(19) United States
(12) Patent Application Publication
(10) Pub. No.: US 2004/0037213 A1
(43) Pub. Date: Feb. 26, 2004

(54) Method and arrangement for locally controlling a testing process in a telecommunications network

(76) Inventors: Ole Droz, Munchen (DE); Rupert Hofer, Roseldorf (AT); Andreas Krenn, Wien (AT); Leopold Schwarz, Hadres (AT); Franz Schmoller, Germering (DE); Stefan Wieser, Wolkersdorf (AT)

Correspondence Address: MORRISON & FOERSTER LLP, 1650 TYSONS BOULEVARD, SUITE 300, MCLEAN, VA, 22102, US

(21) Appl. No.: 10/168,298

(22) PCT Filed: Dec. 13, 2000
(86) PCT No.: PCT/EP00/12666

(30) Foreign Application Priority Data
Dec. 22, 1999 (DE) 199 62 216.7

(51) Int. Cl. H04J 1/12

(52) U.S. Cl. 370/201

(57) ABSTRACT

The invention specifies a method and an arrangement for testing and maintaining a switching center in a telecommunications network and the lines and appliances connected thereto, where control is effected using a test unit provided for this purpose which is connected to any digital subscriber line. This results in a significant increase in the scope of use for the test system, simple introduction of new test methods, performance of extensive tests with a single test unit, and fast and secure data transmission.

### CLAIM FOR PRIORITY

This application is a U.S. national stage of PCT/EP00/12666 filed Dec. 13, 2000 and claims priority to German application DE19962216.7 filed Dec. 22, 1999.

### TECHNICAL FIELD OF THE INVENTION

The invention relates to a system and method for testing in a telecommunications network, and in particular, to maintaining a switching center in a telecommunications network, the appliances, telecommunications terminals and the connections in the telecommunications network.

### BACKGROUND OF THE INVENTION

The large number of subscribers connected to a switching center in a telecommunications network, and the wealth of services provided in a telecommunications network, result in there being a comparatively high likelihood of the occurrence of faults. The great importance of an operational telecommunications network to economic and social existence means that interference on a subscriber line or on the connecting lines in the telecommunications network is a serious technical problem.

To ensure the highest possible degree of transmission reliability, the existing analog transmission technology has been and is being replaced to an increasing extent by digital transmission technology, therefore.

In this context, a signal to be transmitted on an analog basis is divided into discrete steps, with each range created by the division being assigned a binary number. The respective binary number is transmitted digit by digit, that is to say by transmitting a binary pattern comprising zeros and ones, with the zero and the one having various associated value ranges for an electrical variable, usually voltage. Between the two value ranges, there is a range which is not used for transmission. In the case of this technology, interspersed interference therefore has no effect on the transmission quality until the interference signal exceeds this inherently unused range. This is contrasted by analog transmission technology, where in principle any interference has an adverse effect on the transmission quality. Digital technology is thus much less sensitive to interference than analog technology.

In this context, wired transmission technology primarily involves the use of systems which operate on the basis of the standard for “Integrated Services Digital Network”, ISDN for short. More recent technologies also provide packet-switched data traffic for classical telephone networks, however. It is therefore not possible to draw a distinct dividing line between classical telecommunications networks and classical computer data networks at this point. Examples of such standards are the “Transmission Control Protocol/Internet Protocol”, TCP/IP for short, and H.323. However, a wealth of other standards also exists besides the aforementioned examples. Packet-switched voice traffic is also known by the term “Voice over Internet Protocol”, VoIP for short.

In mobile radio networks, by way of example, the standard for “Global System for Mobile Communication”, GSM for short, or the “Standard Universal Mobile Telephone System”, UMTS for short, govern digital transmission technology. In the packet-switched systems, the “General Packet Radio Service”, GPRS for short, is an example of an important standard.

Despite all care, fault tolerances and security mechanisms in the transfer protocols, it is not possible to eliminate interference in the telecommunications network fully, even through the use of digital transmission technology.

Since these lines are used to transmit not only the voice traffic but also, increasingly, important digital data, a fault can have particularly bad consequences in the telecommunications network. To prevent such a fault to a large extent, the components in a telecommunications network are therefore subject to constant monitoring.

DE 19609510 C2, “Leitungsprüfvorrichtung für einen ISDN Bus” [Line testing apparatus for an ISDN bus], dated Mar. 11, 1996, discloses the use of an appliance connected to the ISDN subscriber line's network terminating unit to indicate voltages between the individual wires of the lines. This makes it possible to check the correct wiring or else uninterrupted connection to the telecommunications network.

U.S. Pat. No. 5,128,619 entitled “System and method of determining cable characteristics”, dated Jul. 7, 1992, describes the use of a test unit connected to one end of a line to check the line for faults, to ascertain the impedance, the length, and the attenuation of the line, and finally to establish suitability for digital data transmission.

U.S. Pat. No. 6,064,212 entitled “Method for determining the transmission characteristics of an electric line”, dated May 16, 2000, also discloses that the transmission characteristics of a line can be determined by supplying a specific signal at one end of the line and evaluating the signal received at the other end of the line.

The aforementioned methods thus allow digital lines to be tested provided that it is possible to access at least one end of the line which is to be tested. Employing a technician to carry out the test on-site is costly and also requires a relatively long period of time for fault identification and fault repair. This is contrary to the demand for faults which occur in a telecommunications network to be repaired quickly in order to keep the resultant defect to a minimum. In addition, the service technician needs to carry special test units. This sets narrow boundaries for the technician in terms of the number, size and weight of the required units on the basis of personal attributes.

For the aforementioned reasons, the prior art therefore often involves the incorporation of test functions for testing the subscriber lines or the lines between switching centers into the switching centers in the telecommunications network.

By way of example, these tests comprise

call number oriented testing of subscriber lines.

group testing with listing of the individual measured values.

individual tests of a special type.

supplying analog search tones for line identification.

measuring and storing the characteristic line data.

access to a centrally managed database which stores information about past occurrences, such as the number of faults, the duration and the time of the fault occurring, and the operative responsible for repairing a fault and the resultant time and material requirements. In addition, data about the relative availability, or downtime, in this database are managed, for example.

contacting the subscriber in order to repair a fault.

In this case, the test process is controlled using a control terminal for the switching center or using a personal computer connected to the switching center. The personnel dealing with testing and maintenance does not therefore need to carry out the test on-site, but rather can perform it from the switching center to which the line to be tested is connected. This test system simplifies matters for the service technician, but requires the provision of at least one test station for each switching center.

The defect can often only be repaired on-site, however, which is why the central testing and maintenance measures afford advantages only in as much as the technician can be presented with an analysis of the fault which has occurred as generated from the data available in the switching center. However, for quality assurance purposes, it is frequently necessary to carry out additional tests.

For these reasons, it is highly advantageous to combine test processes taking place centrally and the option of being able to carry out local testing easily as well.

For this purpose, there is a test system which allows local control of a test process taking place in the switching center in order to test components which operate using analog transmission technology. This is done using a personal computer which is connected to the telecommunications network by means of an analog modem and runs a program specifically oriented to this purpose of application. In this case, the control data are transmitted from the personal computer to the switching center, and the results are transmitted from the switching center to the personal computer, using “Dual Tone Multi Frequency Codes”, DTMF codes for short.

However, the diverse nature of the lines and transmission formats used within a telecommunications network means that the scope of action of this system is considerably restricted. Devices in a telecommunications network which transmit data digitally, for example, cannot be tested locally on the basis of the prior art on account of the specific circumstances. In this case, the preventive reasons include, inter alia, the protection of data transmission by means of dedicated check frames or checksums, termination of the subscriber line with a network terminating device in the case of ISDN basic accesses, differences in connection setup as compared with analog technologies, appliance-specific properties of the line modules, and the entirely different processes taking place in a telecommunications network as compared with analog systems.

A prerequisite for the test to be carried out successfully is again communication with the switching center and hence an operational subscriber line. This communication is often not possible, however, since interference therein is the fault which is to be repaired.

### SUMMARY OF THE INVENTION

The invention discloses a method and an arrangement which improve the local control of a test process for testing and maintaining a switching center in a telecommunications network and the lines and appliances connected thereto.

### SUMMARY OF THE INVENTION

In one embodiment of the invention, a test unit is connected to any digital subscriber line in the telecommunications network, and the test process taking place in the switching center for the purposes of testing and maintenance is controlled using the test unit.

The invention attains the following advantages:

test processes stored centrally in the switching center can be altered or extended comparatively easily by the operator of a telecommunications network,

there is a significant increase in the scope of use of a local test system, since the test unit can be connected to the telecommunications network using any digital subscriber line in the telecommunications network,

the test personnel need carry only a single test unit in order to be able to perform a multiplicity of tests and maintenance measures,

any subscriber line in the telecommunications network can be tested, irrespective of connection to a particular switching center,

subscriber lines can also be tested when it is not possible to access a switching center. This is useful, inter alia, in connection with operators of a telecommunications network who have leased parts of a telecommunications network from another company. It is also conceivable, however, for the setup location of the switching center to mean that the switching center is not accessible or is accessible only with considerable difficulty, and

data can be transmitted quickly and securely between the test unit and the switching center.

From the point of view of standardization of classical telecommunications networks and classical computer networks, the term “subscriber line” is also to be understood to mean connections to data networks which are used for digital data traffic or for packet-switched voice traffic, particularly connections to the Internet.

In addition, digital subscriber lines are also understood to mean connections which are simultaneously used for digital transmission and analog transmission on a low frequency band. Such methods are known under the term “Digital Subscriber Line”, DSL for short, and are used to equip existing telephone lines with a high-performance digital access facility in addition to the available voice channel. In this connection, the inventive method relates prefereably to the broadband component of the subscriber line.

However, digital subscriber lines can also be produced by a mobile radio connection, for example, which is used to transmit the data digitally. This context is governed by the GSM standard and the UMTS standard, for example.

In one aspect of the invention, the test process involves measuring electrical parameters for telecommunications terminals, lines and modules, particularly measuring electrical voltages, currents, resistances, capacitances and inductances. This means that fundamental parameters can be measured in the telecommunications network and can be transmitted to the test unit. This function largely replaces the universal test unit which normally needs to be carried by the service engineer.

In another aspect of the invention, the test process involves supplying analog search tones into lines connected to the switching center. This makes it possible to identify individual line wires on a cable harness efficiently.

In another embodiment of the invention, the test process is requested by means of a test unit being carried out as a function of time, particularly with a delay or with cyclic recurrence. This allows a test to be requested for a later time if it is not possible or desirable to start the process for testing or maintenance immediately. A time-consuming or processing-intensive test can be requested, by way of example, for a time at which this operation has no adverse effect on the use of the telecommunications network. In addition, a test can also be requested with cyclic recurrence, and in this way it is possible to obtain, by way of example, a test series which contains measured values for various times.

In one aspect of the invention, a group of individual tests is performed by inputting a single command on the test unit. This allows extensive tests to be carried out easily. In this case, the group of individual tests can be started, by way of example, by transmitting a single command from the test unit to the switching center or by sequentially processing a list stored in the test unit and transmitting a plurality of commands. In this context, the individual tests can also relate to different subscriber lines, in which case a telecommunications terminal connected thereto may also be included. This allows a group of subscriber lines to be tested particularly efficiently. It is also conceivable for a subscriber line test which could not be performed at a particular time owing to a lack of resources to be carried out automatically at a later time.

Another embodiment of the invention provides that the test process reads and alters data which are used for testing and maintaining the switching center or telecommunications terminals connected thereto, the data being stored in a module in the switching center or appliances connected thereto, for example telecommunications terminals, the test process involves reading and altering a data record, relating to a subscriber line, in a database, and the data record including information about past occurrences on the subscriber line, particularly the number of faults, the duration thereof and the time at which they occurred, the relative downtime or the availability, and the operative responsible for dealing with faults which have occurred, and also the associated time and material requirements.

Relevant data can thus be read to test registers from the memory in the modules of the switching center or appliances connected thereto. The data are ascertained and stored by test processes initiated routinely, for example. However, variable data can also include parameters which influence the behavior of the switching center or of an appliance connected thereto. The data are, by way of example, transmission speeds on a line which are manually adjustable or have been obtained in the course of adaptation, and they are used to match the bit rate to the transmission capacity of the line. However, variable data do not need to be used for directly influencing the sequences in the telecommunications network, but rather can also be used merely for documenting particular events, such as a report about a fault which has occurred and the repair thereof. These reports can automatically be delivered to particular people, for example to the subscriber whose subscriber line was reported as being faulty, or else to people employed by the operator or manufacturer of the telecommunications network. In this case, it is possible to use customary transport mechanisms and file formats, for example electronic text messages, e-mail for short, or the “Short Message Service”, SMS for short.

The test process may also involve setting up a call, particularly setting up a connection between the test unit and a telecommunications terminal or setting up an additional call to an existing call between a first telecommunications terminal and at least one second telecommunications terminal. This provides a simple way of getting in touch with another person responsible for testing, or with a subscriber in the telecommunications network whose subscriber line was reported as being faulty. In this case, specific call numbers for relevant call parties can be stored in the test unit for a specific test instruction or can be transmitted to the test unit from the switching center, in order to make it easier for the test personnel to contact these people. In most cases, it will not be necessary to look through telephone books or to inquire at the central office of the testing and maintenance department. Furthermore, the test personnel can set up another call to an already existing call in order, by way of example, to inform the subscribers in question about an imminent test affecting this existing call.

In an aspect of the invention, the switching center to be tested and at least some of the lines and appliances connected thereto are suitable for digital data traffic, particularly for digital data traffic based on the standard for ISDN, GSM and UMTS, and based on standards for packet-switched data traffic, particularly based on the standard H.323 and GPRS. The widespread nature of the standards mentioned results in great scope of use for the local test system. In addition, such test subjects often provide opportunities for testing which far exceed those of analog appliances.

In another aspect of the invention, the communication between the switching center and the test unit takes place on a signaling channel of a digital line, particularly on the D channel of an ISDN line or on the signaling channel of a line operating on the basis of the standard H.323, GSM or UMTS. Since the volume of data to be transmitted is comparatively small in the case of this method, the line's user channel is not affected by the test.

In another embodiment of the invention, the commands provided for controlling the test process are displayed on an output unit for the test unit, are selected using an input unit for the test unit, and are sent to the switching center, with the commands being stored, in particular, in the test unit or being transmitted thereto from the switching center. The test personnel has processes available for testing and maintenance at hand, the processes being able to be started in the switching center, by way of example, by selecting a menu item on the display of a telecommunications terminal. By adding additional data to the displayed command, it is a simple matter to request a test instruction for a subscriber line associated with a call number, for example. If appropriate, data used for testing and maintaining a switching center can also be altered in this way. If the commands are transmitted from the switching center, a particularly powerful method for introducing new functions or for changing existing functions is available, since the changes need be made only in the switching center and not in the individual test units.

In one aspect of the invention, the commands provided for controlling the test process are input and transmitted to the switching center using an audio input unit for the test unit, the commands being stored in the test unit, in particular, or being transmitted thereto from the switching center. This achieves mobility for the person instructed to carry out the test, since both hands are essentially free even when inputting a command. In this case, the command which is input audibly, for example by means of voice, can be converted into a different transmission format and transmitted in the actual test unit itself, or else can also be transmitted without conversion.

In both cases, the transmitted command is evaluated and executed in the switching center.

In another embodiment of the invention, the result of a test is transmitted to the test unit from the switching center. This means that the personnel performing testing and maintenance is provided with the result immediately after the end of a test. On the basis of this result, other decisions can be made quickly, or other test instructions can be transmitted. The transmission itself can be performed using data or voice in this context. It is likewise conceivable for the output to also be visual in the form of text information or graphics on a display for the test unit, or audible as voice or in the form of tones or sounds which each have a certain associated significance, for example from a loudspeaker or earphone. In this case, the result can be conditioned into the appropriate output format either in the switching center or in the test unit itself, for example using a tone or voice generator in the case of audible output.

It is advantageous for controlling the test process, if data and/or program modules are provided which can be used independently of the fundamental platform, particularly data based on the HTML standard or based on the WML standard or program modules based on the JAVA standard. This makes it possible to prevent the generation and transmission of appliance-specific data and/or the creation and use of appliance-specific programs.

The task of HTML is to describe the logical components of a document, and it therefore includes commands for marking typical elements of a document, such as headings, paragraphs, lists, tables or graphics references. Another main component of HTML are references to other documents or places within a document, which are known by the term “links”. HTML has become a governing standard for the Internet.

The use of HTML is advantageous for the invention because, inter alia, it allows tried and tested standard components to be used, such as standard display software for HTML data, known by the term “WWW browser”. The HTML data required for the test process are, by way of example, stored centrally and are transmitted to the test unit as required. Alternatively, these data can be created for each test instruction using a program module, for example in order thus to transmit variable test results from the switching center to the test unit. It is also conceivable, however, for at least some of the HTML data required for controlling the test process to be stored in the test unit.

Like HTML, the task of WML is to describe the logical components of a document, but it additionally includes elements which facilitate the display of information on a comparatively small screen. For this reason, and because the volume of data to be transmitted is relatively small in the case of this method, the use of WML is particularly advantageous for mobile terminals.

WML is part of the Wireless Application Protocol, WAP for short, which is an internationally accepted standard for the dissemination of Internet contents via wireless connections and hence for the convergence between mobile radio and the Internet. The standard is described in “Wireless Application Protocol Architecture Specification, WAP Forum, Apr. 30, 1998”, and is available at the Internet address “http://www.wapforum.org/”, for example.

The use of WML or WAP is advantageous for the invention, inter alia, it allows tried and tested standard components to be used, such as standard display software for WML data, as are used in mobile telephones with WAP capability. The WML data required for the test process are, by way of example, stored centrally and transmitted to the test unit as required. Alternatively, the data can be created for each test instruction using a program module, for example in order to transmit variable test results from the switching center to the test unit. However, it is also conceivable for at least some of the WML data required for controlling the test process to be stored in the test unit.

Since both personal computers and telephones can process the formats mentioned, for example WML or HTML, it is possible, in principle, to use a single format for both appliance classes within the context of the inventive method. Any change to the methods for testing and maintenance therefore needs to be made only for one data format. In addition, essentially the same user interface is also available for the various test units, which is why it is a simple matter for the test personnel to change between the individual appliance classes.

It is also preferable to use platform-independent program modules based on the JAVA standard. JAVA is an entirely platform-independent programming language developed by Sun Microsystems which is specifically oriented to use on the Internet and whose structure and syntax are close to those of the programming language C/C++. Java programs can be referenced in HTML files, in which case the program is loaded into the main memory of the calling computer and is executed there by the Java interpreter in the WWW browser. JAVA is a governing standard for convenient use of the Internet.

An advantage of the invention is that it is independent of particular hardware architectures and operating systems, and tried and tested standard components are available in the case of JAVA. These program modules are, by way of example, stored centrally and transmitted to the test unit as required, where they perform a particular function. Alternatively, it is conceivable for at least some of the program modules required for controlling the test process to be stored in the test unit.

Another embodiment of the invention entails the sequence of the test process being logged in a database in the telecommunications network. These data can later be used for further fault analysis, but are also used, by way of example, to allocate costs which have been incurred.

In an aspect of the invention, the control of a test process is protected against unauthorized access, for example by enabling a particular scope of activities for a particular test unit, or by protection by means of access code. Enabling a particular scope of activities for a particular test unit is used to provide different distributions for the authorization for testing or maintenance within the group of people responsible for testing and maintenance.

In another aspect, it is possible to protect access to various groups of processes using different access codes, in order to demarcate responsibilities within the test personnel in this manner. The different designs of different appliances mean that often only a portion of the possible processes is appropriate. This restriction also applies equally to the switching center and the lines connected thereto.

In another embodiment of the invention, a telecommunications network comprises subscriber lines which are suitable for digital transmission of data. A test unit is connected to the telecommunications network via one of these subscriber lines. The telecommunications network comprises at least one switching center at which lines for these subscriber lines are connected, in which the switching center (VST) manages control processes and data which are required for testing and maintaining the switching center and the lines and appliances connected thereto, and in which the switching center comprises a unit for receiving data which are provided for controlling the test process.

The explanations given for the invention in relation to digital lines apply to the same extent in this case too.

In another aspect of the invention, the switching center comprises external test terminals, to which test units which are independent of the telecommunications network can be connected, for at least some of the connected lines. This significantly increases the flexibility of the test system, since the lines can also be tested using test units which—for economic or technical reasons—are not associated with the switching center. It is a simple matter for the operator of a telecommunications network to perform individual measurement operations.

In another embodiment, an interface to other data networks is advantageous, if (a) data which have been transmitted by the test unit can be forwarded to these data networks, (b) data which have been received from the data networks can be transmitted to the test unit, and (c) data for controlling a test process can be received from these data networks. This allows test processes to be controlled from other data networks too. In addition, appropriate data can be forwarded to the data networks, for example in order to inform a subscriber about the occurrence or repair of a fault by means of an electronic text message. It is also possible to produce and transmit test or maintenance instructions to the tester's test unit, which instructions can, if appropriate, comprise corresponding fault descriptions. This operation can also be performed fully automatically by a program running in the switching center or in an external data network, for example. This allows the tester to carry out the instructions he receives efficiently.

It is preferable if the test unit provided is a telephone. For acceptance by the users of the test system, the potential ability for the process for testing and maintaining a switching center to be controlled from any location is significant. From this point of view, the use of a telephone is an advantageous refinement of the invention, since it provides a very simple way of connecting to the telecommunications network and is available at virtually any location. This is particularly true of mobile telephones. The simple transportability of mobile telephones is of particular importance for use by the service technician because it is normally necessary to carry a large number of other items of equipment when engaged.

It is also preferable if the test unit provided is a personal computer, for example a portable personal computer, equipped with means for connection to a digital subscriber line. On account of its design, a personal computer affords advantageous options for the input and output of data relevant to the test process. In addition, it can be used in a variety of ways and can also be used for other purposes besides operation as a test unit. The use of a portable personal computer additionally eliminates the lack of mobility.

With regard to the increasing use of “Personal Assistants” or “Handhelds”, some of which also provide for connection to data networks by means of mobile radio, a distinct boundary between the appliance classes of laptop and telephone, for example mobile telephone, cannot be indicated at this point. The convergent technology thus combines the advantages of both classes.

### BRIEF DESCRIPTION OF THE DRAWINGS

The invention is explained in more detail with reference to the drawing:

FIG. 1 shows an exemplary arrangement for carrying out the invention.

### DETAILED DESCRIPTION OF THE PREFERRED EMBODIMENTS

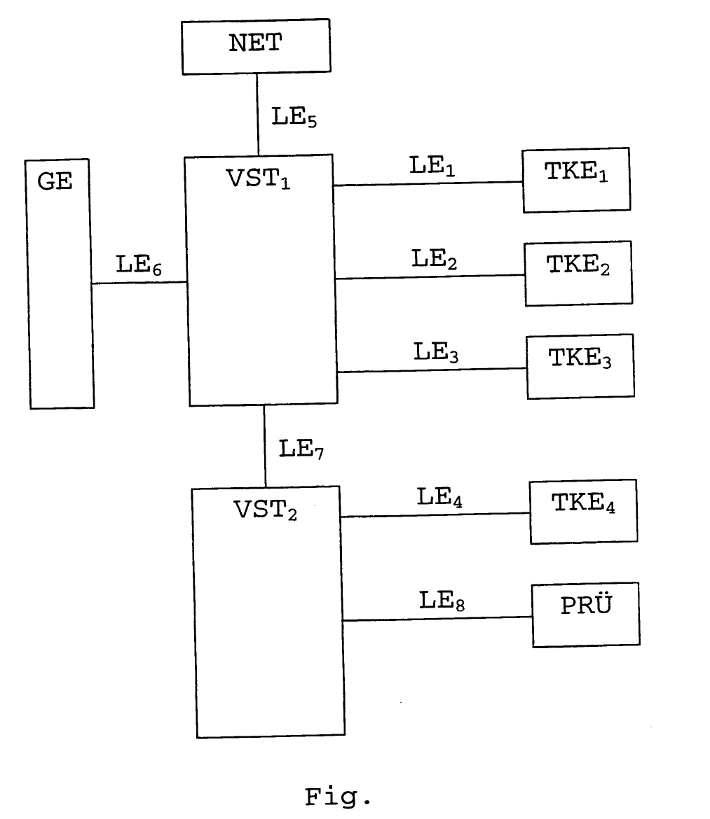

The arrangement shown in the FIG. 1 comprises a first and a second switching center VST₁ and VST₂, four telecommunications terminals TKE₁ . . . TKE₄, a test unit PRÜ, an appliance GE and a data network NET. The first, second and third telecommunications terminals TKE₁ . . . TKE₃ are connected to the first switching center VST₁ by a first, a second and a third line LE₁ . . . LE₃. In addition, the arrangement comprises a connection, produced via a fifth line LE₅, between the first switching center VST₁ and the data network NET, and a connection, produced via a sixth line LE₆, between the first switching center VST₁ and the appliance GE. In addition, the second switching center VST₂ is connected to the first switching center VST₁ by means of a seventh line LE₇. Additionally, the fourth telecommunications terminals TKE₄ is connected to the second switching center VST₂ by a fourth line LE₄, and the test unit PRÜ is connected to the second switching center VST₂ by an eighth line LE₈. In this example, at least the second switching center VST₂ and the test unit PRÜ have a device for sending, receiving and processing digital data, for example in HTML or WML format.

Operation of the arrangement is considered by way of example using a test on the third line LE₃ and on the third telecommunications terminal TKE₃ using test unit PRÜ.

The test unit PRÜ is used to set up a connection to the first switching center VST₁, since the third telecommunications terminal TKE₃ which is to be tested is connected to the first switching center VST₁. A list of the processes stored there for testing and maintenance is then transmitted to the test unit PRÜ and is then shown on a display unit for the test unit PRÜ. If appropriate, program modules can also be transmitted from the first switching center VST₁ to the test unit PRÜ, and are then executed there. The person performing the test selects the required process and sends a start command, possibly including the necessary parameters, to the first switching center VST₁ via the second switching center VST₂. On the basis of this command, the requested process for testing and maintenance is started in the first switching center VST₁. If appropriate, additionally required data can also be requested, or transmitted, on a similar basis to the sequence described above, which results in an interactive sequence for requesting a process. These additional data can, by way of example, comprise the call number of the third telecommunications appliance TKE₃, provided that said call number was not transmitted when the process was started.

When the test has ended, the result is transmitted to the test unit PRÜ from the first switching center VST₁. The test personnel can locate and repair the fault. Finally, the test unit PRÜ is used to write a report and to transmit it to the first switching center VST₁, and the latter forwards the report to the data network NET, for example for the purposes of cost calculation. If appropriate, it is also possible to set up a call from the test unit PRÜ to the third telecommunications terminal TKE₃, in order to inform the subscriber that the defect has been repaired. This request is preferably made by selecting a menu item on the display for the test unit PRÜ, and is again transmitted to the first switching center VST₁ and executed there.

FIG. 1 shows that the test unit PRÜ and the third telecommunications terminal TKE₃ to be tested do not need to be connected to the same switching center VST₁. Instead, the subscribers' telecommunications terminals TKE to be tested can also be distributed in the telecommunications network and can be connected to different switching centers VST.

Furthermore, appliances GE can also be connected to a switching center VST whose purpose is not telephony per se. In addition, the lines LE can also be produced by a radio transmission link.

If similar tests or measures for maintenance need to be performed for the first to fourth telecommunications terminals TKE₁ . . . TKE₄ and for the first to fourth lines LE₁ . . . LE₄, for example, this can be done by inputting a single command on the test unit PRÜ. In this case, a list including a plurality of individual tests and a list including subscriber lines for which these tests need to be performed are produced in advance. The individual commands are then transmitted sequentially to the second switching center VST₂, possibly forwarded to the first switching center VST₁, and are executed in the respective switching center. Alternatively, the collected commands may be transmitted as a whole from the test unit PRÜ to the first switching center VST₁ or to the second switching center VST₂ and for sequential execution first to be performed there.

1. A method for testing and maintaining a switching center in a telecommunications network, the appliances, particularly telecommunications terminals, connected thereto, and the connections in the telecommunications network,
characterized
in that a test unit (PRÜ) is connected to any digital subscriber line in the telecommunications network, and
in that the test process taking place in the switching center (VST) for the purposes of testing and maintenance is controlled using this test unit (PRÜ).

2. The method as claimed in claim 1, characterized in that the switching center (VST) to be tested and at least some of the lines (LE) and appliances (GE) connected thereto are suitable for digital data traffic, particularly for digital data traffic based on the standard for ISDN, GSM and UMTS, and based on standards for packet-switched data traffic, particularly based on the standard H.323 and GPRS.

3. The method as claimed in one of claims 1 to 2, characterized in that the commands provided for controlling the test process are displayed on an output unit for the test unit (PRÜ), are selected using an input unit for the test unit (PRÜ), and are sent to the switching center (VST), with the commands being stored, in particular, in the test unit (PRÜ) or being transmitted thereto from the switching center (VST).

4. The method as claimed in one of claims 1 to 3, characterized in that the result of a test is transmitted to the test unit (PRÜ) from the switching center (VST).

5. The method as claimed in one of claims 1 to 4, characterized in that, for controlling the test process, data and/or program modules are provided which can be used independently of the fundamental platform, particularly data based on the HTML standard or based on the WML standard or program modules based on the JAVA standard.

6. The method as claimed in one of claims 1 to 5, characterized in that the sequence of the test process is logged in a database in the telecommunications network.

7. The method as claimed in one of claims 1 to 6, characterized in that the control of a test process is protected against unauthorized access, particularly by enabling a particular scope of activities for a particular test unit (PRÜ), or by protection by means of access code.

8. An arrangement for carrying out the method as claimed in one of claims 1 to 7,
characterized
in that a telecommunications network comprises subscriber lines which are suitable for digital transmission of data,
in that a test unit (PRÜ) is connected to the telecommunications network via one of these subscriber lines,
in that the telecommunications network comprises at least one switching center (VST) at which lines (LE) for these subscriber lines are connected,
in that the switching center (VST) manages control processes and data which are required for testing and maintaining the switching center (VST) and the lines (LE) and appliances (GE) connected thereto, and
in that the switching center (VST) comprises means for receiving data which are provided for controlling the test process.

9. The arrangement as claimed in claim 8,
characterized
in that an interface to other data networks (NET) is additionally available,
in that data which have been transmitted by the test unit (PRÜ) can be forwarded to these data networks (NET),
in that data which have been received from these data networks (NET) can be transmitted to the test unit (PRÜ), and
in that data for controlling a test process can be received from these data networks (NET).

10. The arrangement as claimed in either of claims 8 and 9, characterized in that the test unit (PRÜ) provided is a telephone.
